(19) United States
(12) Patent Application Publication
(10) Pub. No.: US 2015/0127502 A1
(43) Pub. Date: May 7, 2015

(54) METHOD AND SYSTEM FOR PROCESSING MULTIPLE TRANSACTION DESCRIPTIONS RECEIVED FROM A CLIENT AT A NETWORK-BASED TRANSACTION FACILITY

(71) Applicants: Joshua D. Knepfle, Cincinnati, OH (US); Robert J. Ratterman, Villa Hills, KY (US); Peter Helme, Monte Sereno, CA (US); Michael K. Wilson, San Jose, CA (US)

(72) Inventors: Joshua D. Knepfle, Cincinnati, OH (US); Robert J. Ratterman, Villa Hills, KY (US); Peter Helme, Monte Sereno, CA (US); Michael K. Wilson, San Jose, CA (US)

(21) Appl. No.: 14/595,074

(22) Filed: Jan. 12, 2015

Related U.S. Application Data
(63) Continuation of application No. 09/602,110, filed on Jun. 21, 2000.
(60) Provisional application No. 60/140,124, filed on Jun. 21, 1999.

(51) Int. Cl. G06Q 40/00; G06Q 30/08

(52) U.S. Cl. CPC G06Q 40/12; G06Q 30/08
USPC 705/30

(57) ABSTRACT

Aspects of the present disclose involve a system comprising a computer-readable storage medium storing at least one program and a method to facilitate uploading of a plurality of transaction descriptions to a network-based transaction facility utilizing a client-side upload application and a server-side transaction application. In example embodiments, the method may include receiving a batch text file including a plurality of transaction descriptions. The method may further include instantiating a dedicated parsing process for the batch text file, and identifying each transaction description in the batch text file using one or more tags included therein. The method may further including constructing a collection of transaction listings from the identified transaction descriptions, and committing the collection of transaction listings to an active state.

The present application claims priority from U.S. patent application Ser. No. 09/602,110 entitled “METHOD AND SYSTEM FOR DEFINING AND UPLOADING MULTIPLE TRANSACTION DESCRIPTIONS FROM A CLIENT TO A NETWORK-BASED TRANSACTION FACILITY,” filed Jun. 21, 2000, which claims the benefit of U.S. provisional patent application No. 60/140,124 entitled “METHOD OF DEFINING AND UPLOADING MULTIPLE AUCTIONS TO A NETWORK-HOSTED AUCTION FACILITY FROM A CLIENT APPLICATION,” filed Jun. 21, 1999. The content of the aforementioned applications is incorporated herein, in its entirety, by reference.

### FIELD OF THE INVENTION

The present invention relates generally to the field of network-based commerce and, more specifically, to a method and system to define and upload multiple transaction listings to a network-based transaction facility.

### BACKGROUND OF THE INVENTION

With the wide spread acceptance of the Internet as a ubiquitous, interactive communication and interaction platform, on-line commerce conducted over the Internet has become commonplace in a variety of business environments. On-line commerce is traditionally categorized as business-to-business (B2B), business-to-consumer (B2C), consumer-to-consumer (C2C) and even business-to-employee (B2E) commerce. In the B2B environment, a number of online exchanges or marketplaces (e.g., vertical exchanges) have been established with a view to facilitating electronic commerce between parties, for example, within a vertical supply chain Examples of such B2B exchanges include the PurchasePro exchange and the various exchanges operated by Ventro Corporation. Such B2B exchanges typically provide a number of tools for facilitating commerce, such as aggregated and near real-time inventory information, Requests for Quotation (RFQ) capabilities and auctions.

In the B2C and C2C environments, a number of exchanges and auction facilities have proved popular. A leading on-line auction facility is operated by eBay, Incorporated. On-line auction facilities are also provided by Yahoo! Incorporated and Amazon.com. Further, a number of on-line services offer on-line classifieds, such as the Yahoo! Classifieds service offered by Yahoo! Incorporated.

A number of the on-line auction facilities are utilized by merchants as an important, if not a primary, distribution channel for products. Such so-called “power users” typically place a large number of items up for auction each day. Further, various retailers and merchants also utilize free, or low-cost, classified advertisement services offered on the Internet, such as Yahoo! Classifieds. For example, a used-car sales operation may, at any time, place a number of such classified advertisements via an on-line classified advertisement service.

### SUMMARY OF THE INVENTION

According to the invention there is provided a method to facilitate uploading of a plurality of transaction descriptions to a network-based transaction facility. At a client computer, an upload application is executed to present an input interface to receive a transaction description, the transaction description comprising a plurality of data items and the input interface presenting a plurality of input fields to receive the plurality of data items. At the client computer, the upload application is executed automatically to compose a data file including a plurality of transaction descriptions. At the client computer, the upload application is executed to propagate the data file from the client computer to the network-based transaction facility via a network.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating an exemplary network-based transaction facility, according to one embodiment of the present invention.

FIG. 2 is a database diagram illustrating an exemplary database maintained and accessed by a database engine server of the network-based transaction facility.

FIG. 3 is a block diagram illustrating a network-based transaction environment, according to an exemplary embodiment of the present invention including a client-side and a server-side.

FIG. 4 is a flow chart illustrating a method, according to an exemplary embodiment of the present invention, of facilitating the composition and uploading of multiple transaction descriptions from a client machine to a server machine via a network.

FIG. 5 is a flow chart illustrating a method, according to an exemplary embodiment of the present invention, of downloading an upload application from a network-based transaction facility to a client machine.

FIG. 6 is a flow chart illustrating a method, according to an exemplary embodiment of the present invention, of defining a collection of transaction descriptions.

FIG. 7 illustrates an exemplary input dialog box, according to one embodiment of the present invention.

FIG. 8 illustrates an exemplary main window to present a list and summary of transaction descriptions that constitute a defined collection.

FIG. 9 illustrates an exemplary upload dialog box into which a user may provide a user name and password.

FIG. 10 illustrates an exemplary e-mail format for batch text composed by an upload application, according to an exemplary embodiment of the present invention.

FIG. 11 is a flow chart illustrating a method, according to an exemplary embodiment of the present invention, of processing multiple transaction descriptions as received at a network-based transaction facility.

FIGS. 12A-12I illustrate a series of interfaces that may be presented to a user by a network-based transaction facility so as to allow the viewing, editing, previewing and confirmation of collections of transaction descriptions and of individual transaction descriptions.

FIGS. 13A-13C provide a diagrammatic representation of a database structure, as may be maintained by the database engine server of a network-based transaction facility, according to an exemplary embodiment of the present invention.

FIG. 14 is a class diagram illustrating classes, according to an exemplary embodiment of the present invention, that may be embodied within a client application to support functionality of the present invention.

FIG. 15 is a diagrammatic representation of a machine, in the exemplary form of a computer system within which a set of instruction, for causing the machine to perform any one of the methodologies discussed above, may be executed.

### DETAILED DESCRIPTION

A method and system to define and upload multiple transaction descriptions to a network-based transaction facility are described. In the following description, for purposes of explanation, numerous specific details are set forth in order to provide a thorough understanding of the present invention. It will be evident, however, to one skilled in the art that the present invention may be practiced without these specific details.

The term “participant” shall be taken to refer to any entity, human or automated, that contributes to, or participates in, a transaction, communication or process.

The term “transaction” shall be taken to mean any communication between two or more parties with a view to establishing a business agreement, exchange of value or a commercial relationship. Accordingly, the word “transaction” shall be deemed to cover, but not be limited to, a purchase-and-sale transaction established as a result, for example, of the placement of an advertisement or as a result of the conclusion of an auction process, the auction process being conducted on-line or otherwise.

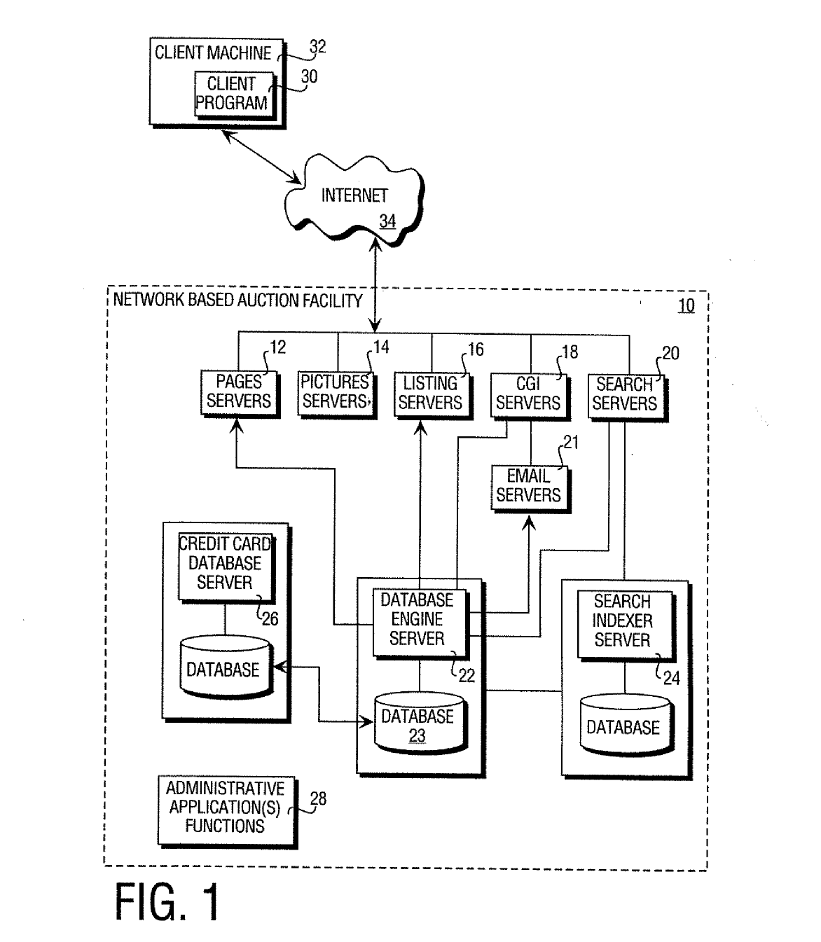

FIG. 1 is block diagram illustrating an exemplary networked-based transaction (or commerce) facility in the form of a network-based auction facility 10. While an exemplary embodiment of the present invention is described within the context of an auction facility, it will be appreciated by those skilled in the art that the invention will find application many different types of computer-based, and network-based, commerce or transaction facilities. For example, the present invention may be applied to an on-line classified advertisement service, a network-based exchange (e.g., a B2B exchange) or other on-line marketplace.

The auction facility 10 includes one or more of a number of types of front-end servers, namely page servers 12 that deliver web pages (e.g., markup language documents), picture servers 14 that dynamically deliver images to be displayed within Web pages, listing servers 16, CGI (or ISAPI) servers 18 that provide an intelligent interface to the back-end of facility 10, and search servers 20 that handle search requests to the facility 10. E-mail servers 21 provide, inter alia, automated e-mail communications to users of the facility 10.

The back-end services include a database engine server 22, a search index server 24 and a credit card database server 26, each of which maintains and facilitates access to a respective database. The back-end is also shown to include a number of administrative applications or functions 28.

The network-based auction facility 10 may be accessed by a client program 30, such as a browser (e.g., the Internet Explorer distributed by Microsoft Corp. of Redmond, Wash.) that executes on a client machine 32 and accesses the facility 10 via a network such as, for example, the Internet 34.

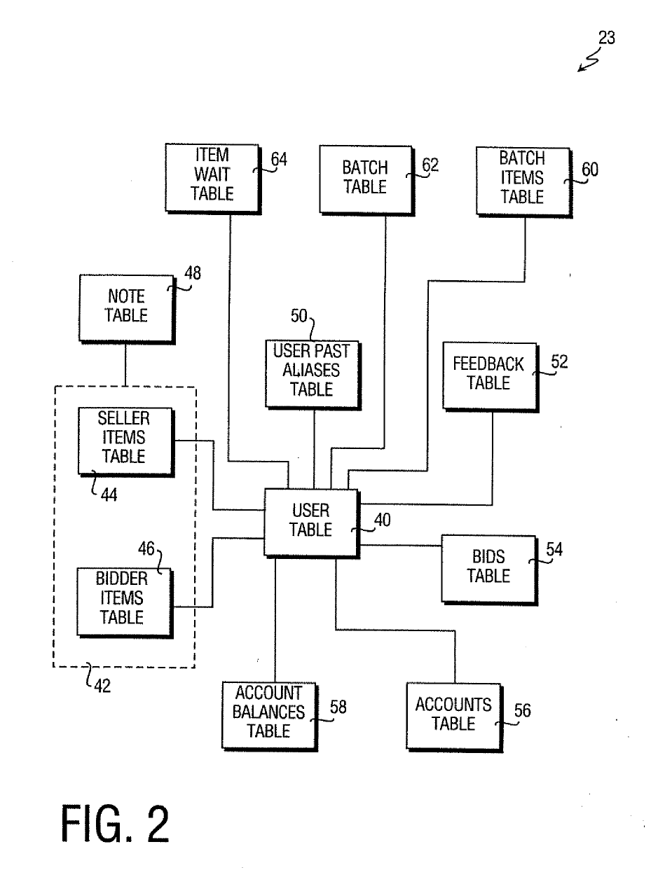

FIG. 2 is a database diagram illustrating an exemplary database 23, maintain by and accessed via the database engine server 22, that at least partially implements and supports the auction facility 10. The database 23 is a relational database, and includes a number of tables having entries, or records, that are linked by indices and keys. Central to the database 23 is a user table 40, which contains a record for each user of the auction facility 10. A user may operate as a seller, buyer, or both, within the auction facility 10. The database 23 also includes items tables 42 that may be linked to the user table 40. Specifically, the tables 42 include a seller items table 44 and data items table 46. A user record in the user table 40 may be linked to multiple items that are being, or have been, auctioned via the facility 10, a link indicating whether the user is a seller or a bidder (or buyer) with respect to items for which records exist within in the items tables 42. The database 23 also includes a note table 48 populated with note records that may be linked to one or more item records within the items tables 42 and/or to one or more user records within the user table 40. Each note record within the table 48 may include, inter alia, a comment, description, history or other information pertaining to an item being auction via the auction facility 10, or to a user of the auction facility 10.

A number of other tables are also shown to be linked to the user table 40, namely a user past aliases table 50, a feedback table 52, a bids table 54, an accounts table 56, and an account balances table 58.

To enable one embodiment of the present invention, the database 23 is also shown to include a batch table 60, a batch items table 62 and an items wait table 64. Further details regarding the database tables 60-64 are provided below.

The present invention relates to a method and system for assisting in the communication of multiple transaction descriptions (e.g., offers for sale, auctions, listings) to a network-based transaction facility. In one embodiment, an executable upload application 76 is installed and executed on a client computer with a view to assisting a user in uploading multiple transaction descriptions to a network-based transaction facility. The upload application 76 thus operates as a client application, and provides a number of user interfaces and other functionality to assist a user in defining multiple transaction descriptions in a convenient manner. The upload application 76 also operates to compose a data file that includes the multiple transaction descriptions, and to upload such a data file as a single transmission to a network-based transaction facility. The uploading of such a single data including multiple transaction descriptions is advantageous in that it reduces the number of interactions between a client machine and the network-based transaction facility and the amount of time that a client machine has to be connected to a network (i.e., be “on-line”).

As the upload application 76 is executable on the client-side, it is further advantageous in that it allows a user to compose multiple transaction listings in an “off-line” manner (e.g., without necessarily establishing any network communications or session with a network-based transaction facility), and then to upload such multiple transaction descriptions to the transaction facility as the above-mentioned single data file transmission. This is particularly advantageous for users that connect to a network utilizing a dial-up modem, as the composition and uploading of multiple transaction descriptions does not require the user's telephone line to be continually dedicated to a network connection during the composition and uploading of multiple transaction descriptions.

A further advantage of a client-side executable upload application is that improved functionality can be delivered at the client-side. Specifically, client-side executable applications often provide advanced interface functionality, examples of which are provided below (e.g., the use of templates to pre-populate fields and the verification of input information prior to upload to a network-based transaction facility).

On the server-side, one embodiment of the present invention discloses the parsing and verification of multiple transactions as received from the upload application by the network-based transaction facility. Further, one embodiment of the present invention discloses server-side facilitated viewing, editing and confirmation of multiple transaction listings by a user, and also the committing of such multiple transaction descriptions to an active state to initiate multiple transaction processes facilitated by the network-based transaction facility.

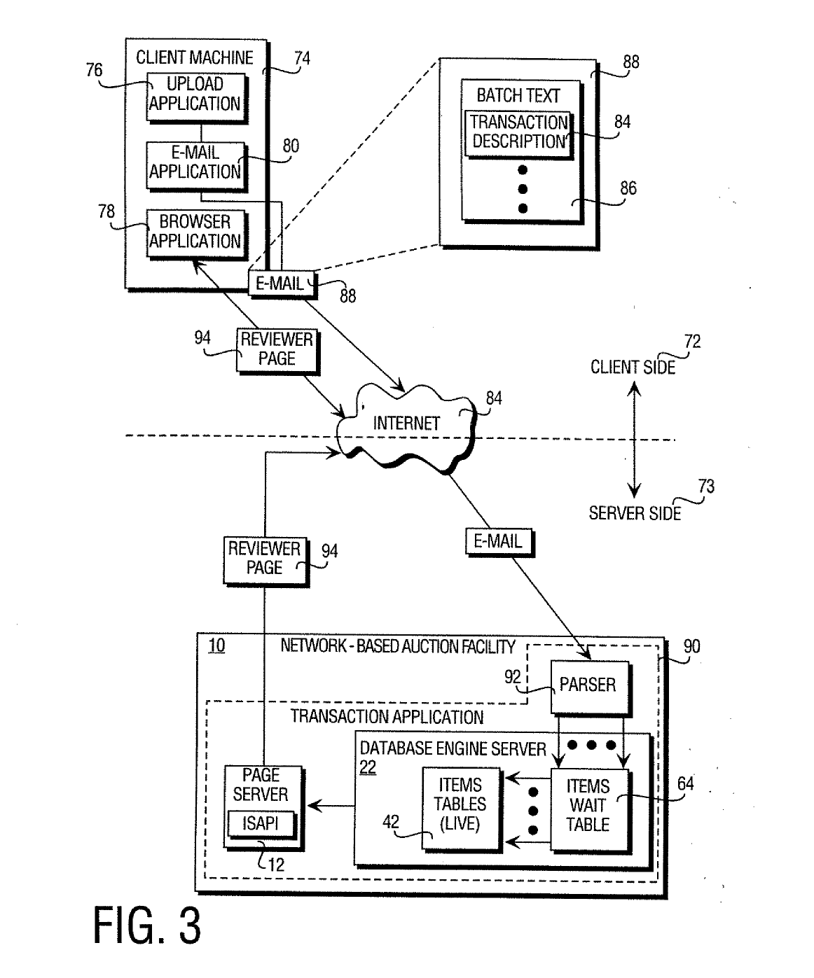

FIG. 3 is a block diagram illustrating a network-based transaction environment 70, according to an exemplary embodiment of the present invention, the environment 70 including a client-side 72 and a server-side 73. On the client-side 72, a client machine 74 (e.g., a personal computer, Personal Digital Assistant (PDA), cellular telephone or any other network device) is shown to host an upload application 76, a browser application 78 and an e-mail application 80. The client machine 74 is coupled to a network in the exemplary form of the Internet 82, or any Local Area Network (LAN) or Wide Area Network (WAN). The upload application 76, in one embodiment, presents a number of user interfaces to a user for the purposes of harvesting multiple transaction descriptions 84. The upload application 76 further composes batch text 86 that embodies the multiple transaction descriptions 84 inputted via the multiple interfaces. The upload application 76 then interacts with the e-mail application 80 to compose an electronic mail (e-mail) message 88 that embodies the batch text 86. The batch text 86 is communicated to the network-based auction facility 10 by the e-mail application 80 as the e-mail message 88. Specifically, the e-mail application 80 utilizes any one of a number of electronic e-mail or messaging protocols (e.g., Simple Mail Transport Protocol (SMTP)) to communicate the e-mail message 88 over the Internet 82. It will of course be appreciated, in alternative embodiments, the batch text 86 may be communicated to the network-based auction facility 10 by any one of a number of other protocols (e.g., the File Transport Protocol (FTP)).

Turning to the server-side 73, the network-based transaction facility, in the exemplary form of the auction facility 10, is shown to execute a transaction application 90 that includes a parser 92. The parser 92 operates to parse a received e-mail message 88 to extract the multiple transaction descriptions 84 from the batch text 86 included within the e-mail message 88. The parser 92 may also perform various format, content and verification operations, as will be described in further detail below. The parser 92 then populates the items wait table 64, as maintained by the database engine server 22, with the extracted transaction descriptions 84. From the items wait table 64, the transaction descriptions 84 are transferred to the live items table 42, following user confirmation in the manner described below.

The transaction application 90 further encompasses the page server 112, which in one exemplary embodiment, includes an Internet Server Application Program Interface (ISAPI) where the page server 112 comprises the Internet Information Server, a web server developed by Microsoft Corporation of Redmond, Wash. In an alternative embodiment, the page server 112 may execute a Common Gateway Interface (CGI) program. The page server 112 operates dynamically to generate markup language documents (e.g., web pages) utilizing content retrieved from the database engine server 22, and to communicate such markup language documents via the Internet 82 to the client machine 74 for viewing utilizing the browser application 78. In one embodiment, the page server 12 serves up a reviewer page 94, embodying a list of multiple transaction descriptions 84 successfully extracted by the parser 92 from the e-mail message 88 for display within the browser application 78. This is done for the purposes of allowing a user to view, edit, and confirm such transaction descriptions 84 before they are communicated to the live items table 42 from the items wait table 64.

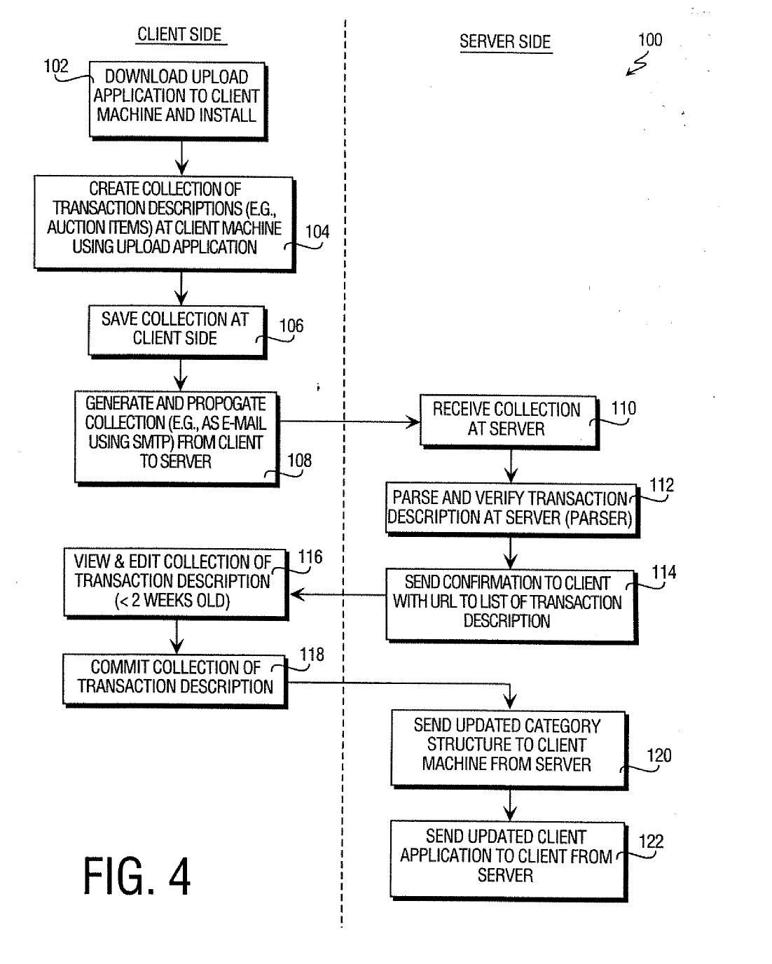

FIG. 4 is a flow chart illustrating method 100, according to an exemplary embodiment of the present invention, of facilitating the composition and uploading of multiple transaction descriptions from a client machine to a server machine via a network. In an exemplary embodiment where the transaction facility comprises the network-based auction facility 10, the transaction descriptions define the parameters and content of an on-line auction process. Nonetheless, it will be appreciated that a transaction description may provide any transaction parameters (e.g., a product or service that is being offered for sale by any methodology, or a product service requirement description). Specifically, in an alternative embodiment, the transaction descriptions may describe a product or service being offered by way of a classified advertisement or that has been offered or is required within the context of a B2B exchange or electronic marketplace.

The method 100 commences at block 102 at the download of the upload application 76 to a client machine 74, and the installation of the upload application 76 on the client machine 74.

At block 104, a user then creates a collection of transaction descriptions (e.g., auction listings) at the client machine 74 utilizing the upload application 76.

At block 108, the batch text 86, comprising the collection of transaction descriptions 84, is composed and propagated as the e-mail message 88 from the client machine 74 to the server side 73 via the internet 82.

At block 110, the e-mail 88 is received at the network-based auction facility 10.

At block 112, the parser 92 of the transaction application 90 parses the e-mail message 88 to extract the various transaction descriptions 84 embodied therein, and performs various verification operations with respect to each of the each of the extracted transaction descriptions 84.

At block 114, the transaction application 90 communicates a confirmation message to the client machine 74 to confirm successful receipt and extraction of the various transaction descriptions 84. In one embodiment, the confirmation message may comprise an e-mail message communicated from the e-mail service 21 of the network-based auction facility 10. In an alternative embodiment, the page server 12 may, responsive to a user request, generate a markup language document (e.g., a HTML document) that communicates the confirmation message to the user. The confirmation message communicated to the client machine 74 at block 114 may further include a location identifier (e.g., a Uniform Resource Locator (URL)) that provides a link to a listing of the collection of transaction descriptions extracted by the parser 92 at block 112.

In an alternative embodiment, the confirmation message itself may present such a list of transaction descriptions. For example, the confirmation message that is communicated via e-mail to the client machine 74 may comprise an HTML document that provides a list of transaction descriptions included within the collection.

At block 116, the user is presented with a number of interfaces that facilitate viewing and editing of the collection of transaction descriptions. In one embodiment, the various interfaces may be markup language documents that are generated by the page server 12 and communicated to the client machine 74 via the Internet 82 for viewing within the context of the browser application 78. For example, such interfaces in the form of markup language documents may be invoked by user-selection, on the client-side, of a URL included within the confirmation message communicated at block 114. In an alternative embodiment, the interfaces presented at block 116 may be generated by the upload application 76 utilizing, for example, text and data communicated from the transaction application 90.

At block 118, the user, via an appropriate interface, elects to commit the transaction descriptions 84 to a transaction process facilitated by the network-based auction facility 10. For example, the user may elect to commit the collection the transaction descriptions 84 as auction processes to be commenced on a specified date and at a specified time.

At block 120, following commitment of the collection of transaction descriptions 84, the transaction application 90 may communicate an updated category data structure to the client machine 74, and specifically to the upload application 76. In one embodiment, the creation of the collection of transaction descriptions 84 may require a user to specify a category for transaction subject matter. It is useful for the upload application 76 to specify categories that are supported by the transaction application 90. Accordingly, the communication of the category data structure at block 120 serves to synchronize the categories that may be specified utilizing the upload application 76 with the subject matter categories that are supported by the transaction application 90. Specifically, the database 23 of the network-based auction facility 10 may include a categories table (not shown) that lists a set of subject matter categories according to which the subject matter of a transaction may be classified. Such classification of subject matter is important to facilitate the user searching and location of transaction descriptions that may be of interest.

At block 122, the transaction application 90 may communicate an updated upload application 76) to the client machine 74. In one embodiment, the transaction application 90 may query an installed upload application 76 to determine a version number (or install date) thereof. This installed version number may be compared by the transaction application 90 to a current version number for the upload application 76, the current version number being the version number for the most recent version of the upload application 76. In the event that the current version of the upload application 76 is more recent than installed version, a user may be presented with the option of downloading the current version of the upload application 76. Specifically, an e-mail message may be communicated to the client machine 74 stating that a more recent version of the upload application 76 is available. The e-mail message would further include a location identifier (e.g., URL) that is user-selectable to commence initiation of the download of the client version of the upload application 76. In an alternative embodiment, the transaction application 90 may cause the upload application 76 to prompt a user to upgrade the version of the upload application 76. The user may then respond to this prompt to commence an upgrade process.

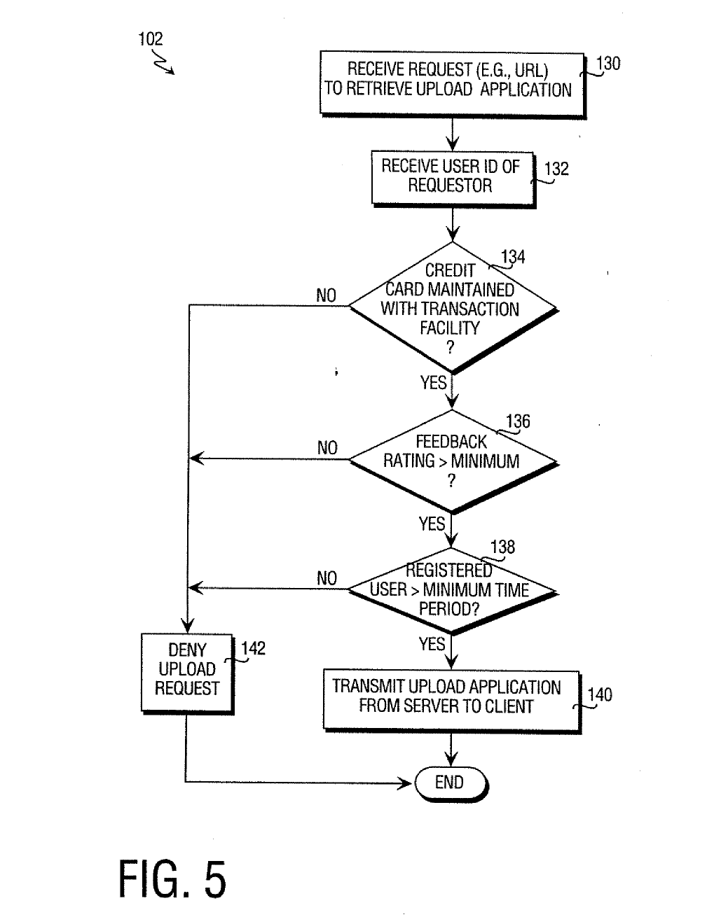

FIG. 5 is a flow chart illustrating a method 102, according to an exemplary embodiment of the present invention, of downloading the upload application 76 from the network-based auction facility 10 to a client machine 74.

At block 130, the network-based auction facility 10 receives a request to upload the upload application 76. In one embodiment, this request may be received by user-selection of a hypertext link, or other location identifier, presented to the user within the context of a markup language document displayed by the browser application 78.

At block 132, the network-based auction facility 10 further receives a user identifier for the requesting user. The user identifier is provided by the user via an interface, for example, presented to the user in the form of a markup language document displayed by the browser application 78.

At decision block 134, a determination is made by the auction facility 10 as to whether the requesting user maintains credit card details with the auction facility 10. Specifically, should the requesting user be a registered user of the auction facility 10, the auction facility 10 may during a registration process request the relevant user to provide details of a valid credit card.

At decision block 136, a determination is made by the auction facility 10 as to whether a negative feedback rating for the requesting user exceeds a predetermined minimum. Specifically, in one embodiment, the auction facility 10 provides a feedback mechanism by which users may provide feedback regarding other users with which they have transacted. Such a feedback mechanism is useful for establishing trust between users of the on-line auction facility 10, and also provides an indication of the trustworthiness and reliability of the user.

At decision block 138, a determination is made as whether the requested user has been a registered user of the on-line auction facility 10 for a predetermined time period. For example, should the requesting user have only been a registered user for a number of hours, or less than a week, insufficient time may have passed to establish the credibility, trustworthiness and reliability of the requesting user. Further, a user seeking to perpetrate a fraud utilizing the on-line auction facility 10 may register under an alias for the specific purposes of perpetrating such a fraud. The check performed at block 138 seeks to reduce access to the upload application 76 by a user who has not been registered for a sufficient period of time so as to increase the probability of the detection of a fraudulent registration.

Following a negative determination at any one of decision blocks 134, 136 or 138, the method 102 denies the upload request at block 142. On the other hand, following positive determinations at each of decision blocks 134, 136 and 138, the auction facility 10, at block 140, proceeds to propagate the upload application 76 to the client machine 74 via the network 82.

The method 102 then terminates at block 144.

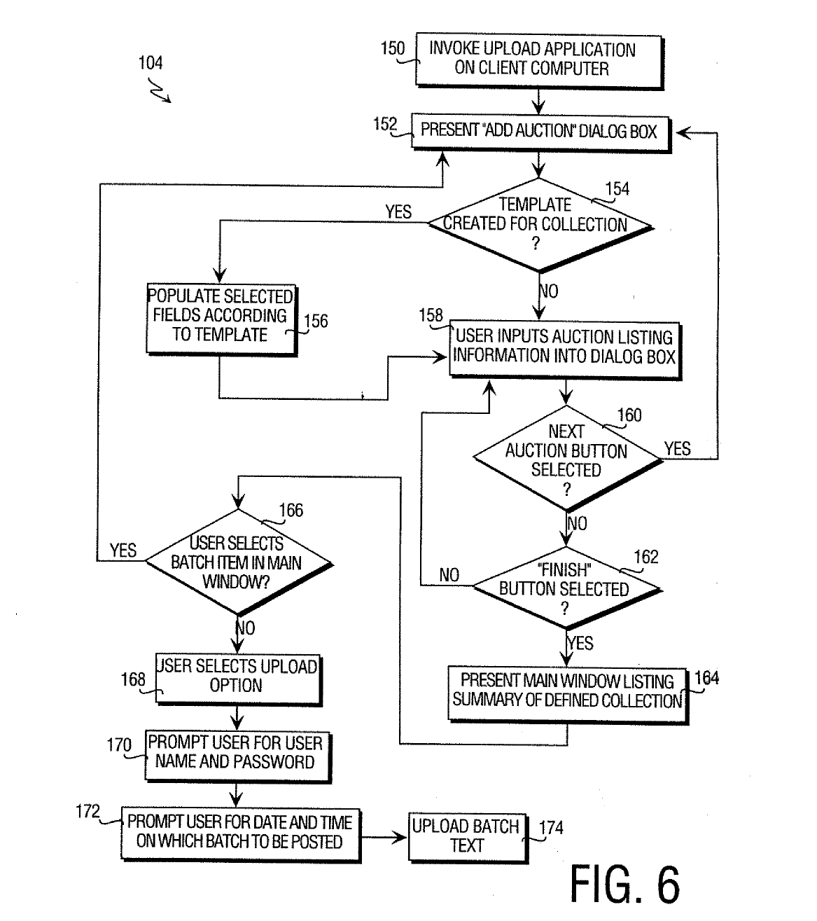

FIG. 6 is a flow chart illustrating a method 104, according to an exemplary embodiment of the present invention, of defining a collection of transaction descriptions 84, such as for example, auction listings. In one embodiment, the method 104 is performed at the client-side by the stand-alone, executable upload application 76. In alternative embodiments, the method 104 may be executed by a client-side executable, such as a Java applet or an ActiveX control, that executes when the context of a browser application. The method 104 is advantageous in that intelligence resides on the client-side to facilitate the convenient entry of multiple transaction descriptions by, for example, providing templates that allow for a user to define repetitive content across multiple transaction listings so as to avoid requiring repetitive entry for each transaction listing. Further, the method 104 introduces client-side functionality to perform a verification operation on inputted data to check for allowable contents, and the legality of contents. Further, the method 104 proposes presenting lists for allowable contents, for example as drop-down menus, from which a user may select valid contents for a particular field of a transaction description 84.

The method 104 commences at block 150 with the invoking of the upload application 76 on the client machine 74 of a user wishing to compose and upload multiple transaction descriptions to a network-based auction facility 10. For example, a “power-user” of the eBay auction facility may wish to upload multiple auction listings, thus invoke an upload application 76.

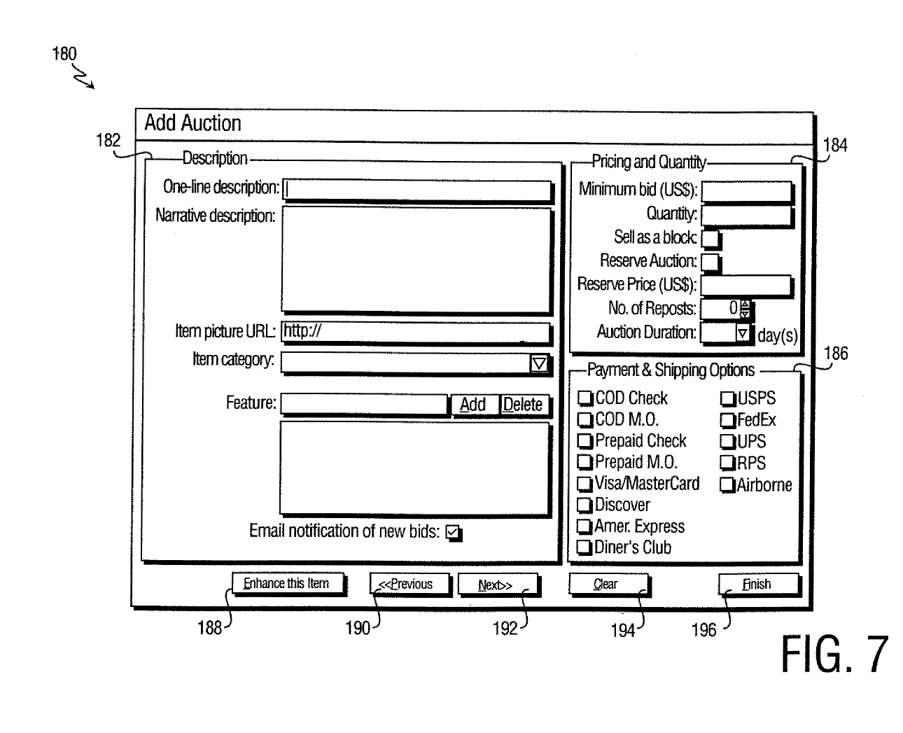

At block 152, the upload application 76 executes to present an input dialog box to receive a transaction description 84. The dialog box, in one embodiment, presents a number of fields that may be populated by the user to compose the transaction description 84. In one embodiment, the input dialog box presented at box 152 comprises an “add auction” dialog box 180, an exemplary embodiment of which is shown in FIG. 7.

The “add auction” dialog box 180 is shown to include multiple input fields for receiving various data items to constitute an exemplary transaction description 84. These data items are broadly shown to comprise the description data items 182, pricing and quantity data items 184 and payment and shipping data items 186. An “enhance this item” button 188 is also presented so as to allow a user to specify that a particular transaction be visually or otherwise differentiated or highlighted when displayed by the network-based auction facility 10. For example, an auction listing derived from the transaction description 84 may be bolded, displayed with a particular background color, or have a graphic image or icon associated therewith.

To facilitate convenient navigation between multiple transaction descriptions 84 inputted by the “add auction” dialog box 180, “previous” and “next” buttons 190 and 192 are also displayed, user-selection of which allows a user sequentially to progress through multiple inputted transaction listings.

A “clear” button 194 is also presented, user-selection of the button 194 operating to clear all data inputted into the various input fields of the “add auction” dialog box 180.

Finally, a “finish” button is presented for user-selection to indication to indicate the conclusion of the input of the collection of multiple transaction descriptions 84.

At decision block 154, the upload application 76 makes a determination as to whether an input template has been created and defined for the relevant collection of transaction descriptions being inputted. Specifically, a template may be created by a user to contain data items for transactions that are common from transaction description to transaction description. For example, if all auctions in a particular collection can be paid for by Master Card, this data item may be entered into a template for automatic inclusion within each auction listing of the relevant collection.

Following a positive determination at decision block 154, at block 156, one or more fields of the input dialog box may be prepopulated with information retrieved from the appropriate template.

Following a negative determination at decision block 154, or following completion of block 156, at block 158, the user then inputs data items into the input dialog box. For example, the various fields of the ‘add auction” dialog box are populated manually by a user, or by user-selection of predetermined content from a presented list (e.g., a drop-down menu). For example, the “item category” 198 presented by the “add auction” dialog box 180 may be populated by user-selection of the drop icon 200, which then presents to the user a predetermined list of valid categories. By selecting one of the categories presented in the drop-down menu, the “item category” field 198 is populated.

At block 158, the upload application 76 also checks each entered data item for legality and correct format. Merely, for example, inputs into “minimum bid” and “quantity” fields 202 and 204 will be checked by the upload application 76 to insure that the inputs are numeric values.

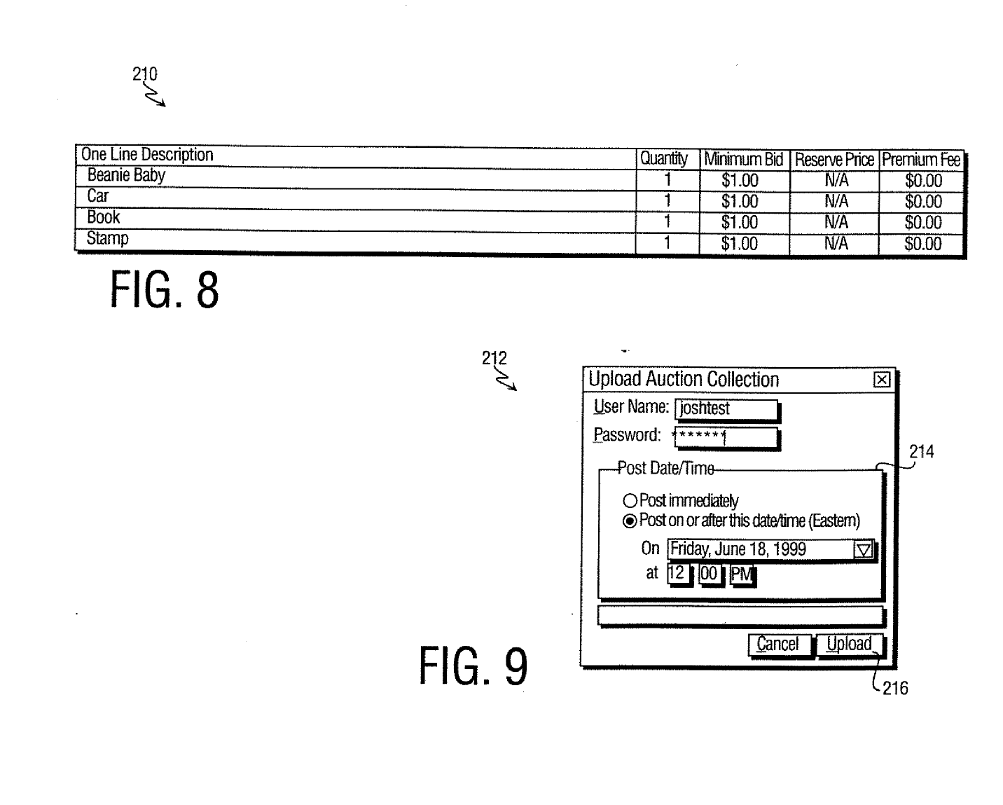

At decision block 160, a determination is made as to whether the user has selected the “next” button 192 to indicate an intention input of a further transaction description 84. At this point, the upload application 76 performs a verification check to determine whether the user has inputted sufficient data items to constitute a valid transaction description 84, or whether further information is required. For example, the user may inadvertently have forgotten to input a minimum bid into the field 202. Assuming the absence of any outstanding data items, following user-selection of the “next” button 192, the method 104 loops back to block 152 and again presents a fresh input dialog box. On the other hand, following a negative determination at decision block 160, a determination is made at decision block 162 whether the “finish” button 196 has been user-selected. If not, the method 104 loops back to block 158 on the assumption that the user wishes to input further data items. Following a positive determination at decision block 162, the method 104 progresses to block 164, where the upload application 76 presents a main window 210, an exemplary embodiment of which is shown in FIG. 8. The main window 210 presents a listing summary of all transaction descriptions 84 that constitute the defined collection. Specifically, the main window 210 includes columns that display titles, quantity, minimum, reserve price and premium listing price in a tabular form to the user. A user may double-click on any of the rows of transaction listings presented in the main window 210, which user-selection will be detected at decision block 166, causing the method 104 to loop back to block 104 where an input dialog box is displayed, the fields of the input dialog box being populated with data items for the selected transaction description 84.

At block 168, the user selects an upload option presented in association with the main window 210, responsive to which the upload application 76 prompts the user for a user name and password at block 170. In one exemplary embodiment, the prompting at block 170 is performed via a upload dialog box 212, such as that shown in FIG. 9 which includes input fields for the relevant user name and password.

At block 172, the user option may also be prompted for a date and time at which the relevant collection of transaction descriptions 84 should be posted by the network-based transaction facility. For example, the upload dialog box 212 shown in FIG. 9 is shown to include is shown to include a post date/time section 214 that allows a user to specify whether a collection of auction listings should be posted immediately, or posted on or after a specified date that the user may input. In the exemplary embodiment of the network-based auction facility 10, the “posting date” is the date on which a series of auctions are commenced based on the collection of auction listings.

At block 174, the user may then upload the collection of transaction descriptions 84, as a single data file composed by the upload application 76, to the network-based auction facility 10 by the selection of the “upload” button 216 presented within the upload dialog box 212.

In one embodiment, the collection of transaction descriptions 84 is, as described above, uploaded as batch text 86 embodied within an e-mail message 88 communicated, via an e-mail communication 80, from the client machine 74 to the network-based auction facility 10. In alternative embodiments, the data file may be transferred via a non-e-mail protocol, such as MTP.

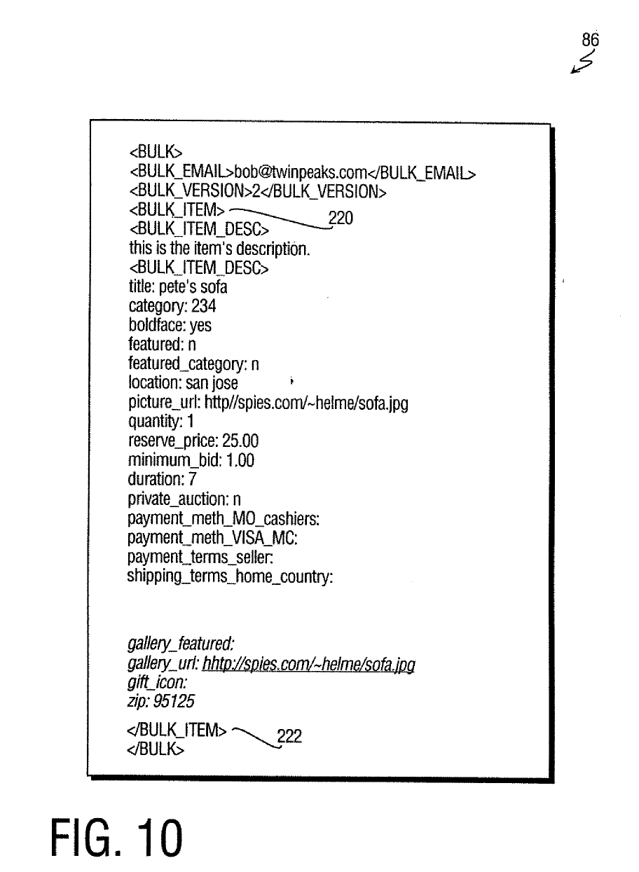

FIG. 10 shows an exemplary e-mail formatting for the batch text 86, with tags utilized to demarcate and identify transaction descriptions 84, and data items within such transaction listing. For example, <BULK_ITEM> and </BULK_ITEM> tags 220 and 222 are utilized to demarcate discrete transaction descriptions 84. Within each discrete transaction description 84, various data items comprising the transaction description 84 are indicated and associated with appropriate titles. The tag delimiters and titles are, as will be described below, meaningful to the parser 92 of the network-based auction facility 10.

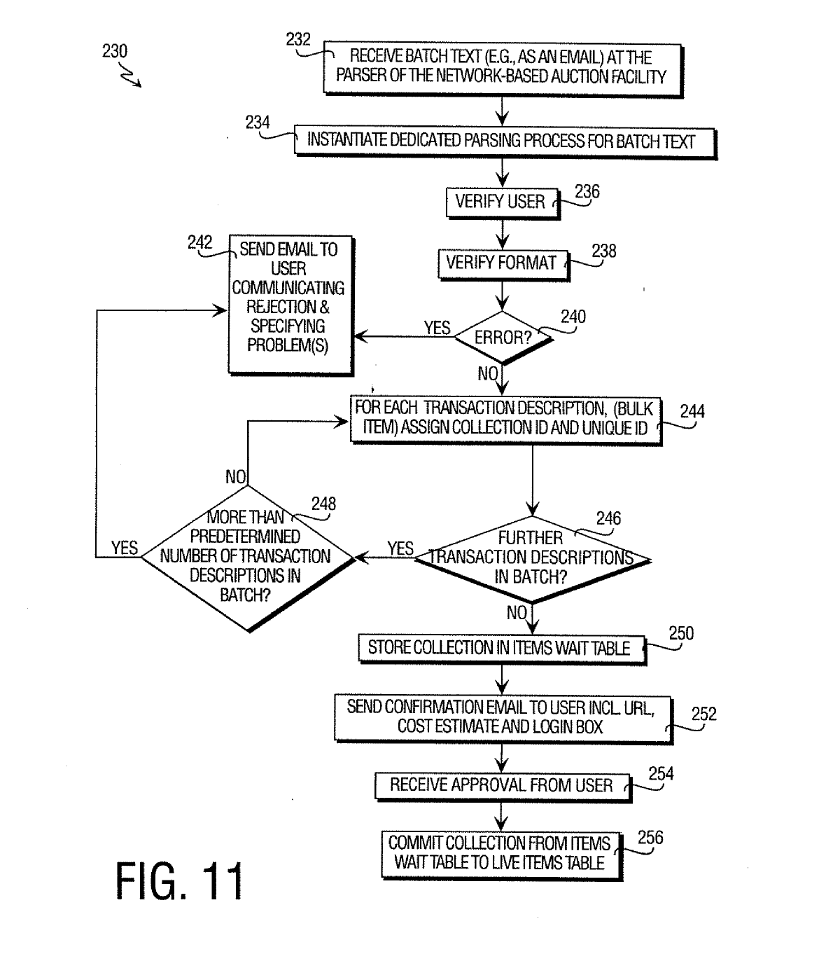

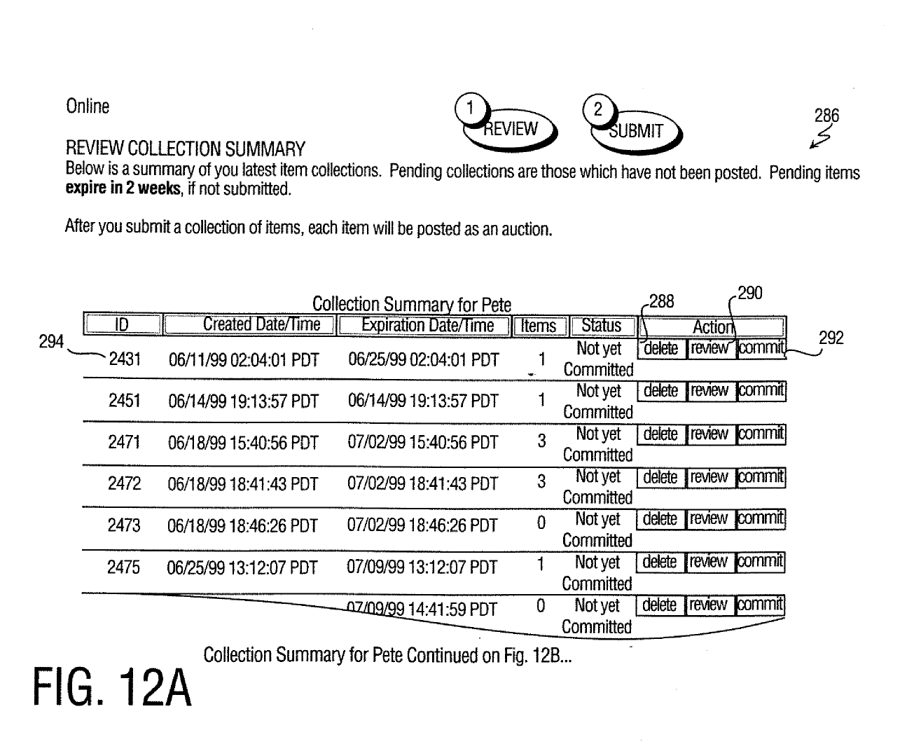

FIG. 11 is a flow chart illustrating a method 230, according to an exemplary embodiment, of processing multiple transaction descriptions 84 as received at a network-based transaction facility, such as the network-based auction facility 10. Accordingly, the method 230 reflects, in one embodiment, activities performed on the server-side 73 of the transaction environment 70 illustrated in FIG. 3. It will of course be appreciated that, in alternative embodiments, some will be described functionally may be moved to the client-side 72.

The method 230 commences at block 232 with the receipt of the batch text 86, for example in the form of the e-mail message 88, at the parser 92 of the network-based auction facility 10. The parser 92 processes the batch file 86 by recognizing the delimiter tags and titles discussed above with reference to FIG. 10 to be thereby reconstruct a collection of multiple transaction descriptions, in an exemplary form of auction listings. More specifically, at block 234, the parser 92 instantiates a dedicated parsing process (or thread) for each batch text 86 received at the parser 92 by employing a dedicated parsing process for each batch text 86, the simultaneous parsing of multiple batch text received at the parser 92 may be implemented. Further, implementation of multiple parsing processes enhances the scalability of the transaction application 90 to handle a relatively large volume of batch text 86 received at the network-based auction facility 10.

At block 236, for each batch text, 86 the user identifies for the sender of the batch text 86 is verified as being for a registered user of the network-based auction facility 10. Specifically, the parser 92 may, in one embodiment, extract an e-mail address of the sender embedded within the batch text 86 by the upload application 76. This e-mail address may be compared against an appropriate field within the user table 40 to identify the uploading user as being a registered user.

At block 238, the parser 92 may optionally verify the format of data items of the respective multiple transaction descriptions 84 as embodied within the batch text 86. The verification operation performed at block 238 provides an additional verification step over and above that implemented by the upload application 76, and serves to further provide a safeguard against data corruption during the transmission of the batch text 86.

At decision block 240, a determination is made as to whether an error has occurred either as a result of the user not being registered or a format inconsistency. If such an error is detected, at block 242, an e-mail message is communicated from the network-based auction facility 10, and specifically the e-mail servers 21 thereof, to the e-mail application 80 resident on the client machine 74 of the user. The e-mail communicated at block 242 specifies that the collection of transaction descriptions 84 has been rejected, and may optionally provide a reason for the rejection. For example, the e-mail message may specify that the relevant e-mail address is not recognized as belonging to a registered user, or that a specific formatting error has been detected.

On the other hand, should no error be detected at decision block 240, the method 230 proceeds to block 244 where each transaction description 84 of a collection of transaction descriptions 84 is assigned a collection identifier that is common to all transaction descriptions within a particular collection, and a unique identifier that uniquely identifies each transaction description 84.

The operation performed at block 244 is performed with respect to each transaction description 84, a determination being made at decision block 266 after the processing of each transaction description 84 whether further transaction descriptions 84 exist within a particular collection (or batch). If so, at decision block 248, a determination is made as to whether more than a predetermined number (e.g., 500) of transaction descriptions 84 are present within a particular collection (or batch).

Following a positive determination at decision block 248, an error message, in the form of an e-mail, is again communicated to the sending user at block 242. Following a negative determination at decision block 248, the method 230 loops back to block 244, to assign a collection identifier and unique identifier to a further transaction description 84 within the relevant collection.

Should a determination be made at decision block 246 that no further transaction descriptions 84 exist within a particular collection, the method 230 proceeds to block 250 where the collection of transaction descriptions 84 is stored within the items wait table 64, maintained by the database engine server 22. Specifically, the items wait table 64 servers to hold the various transaction descriptions 84 pending confirmation thereof by the sending user.

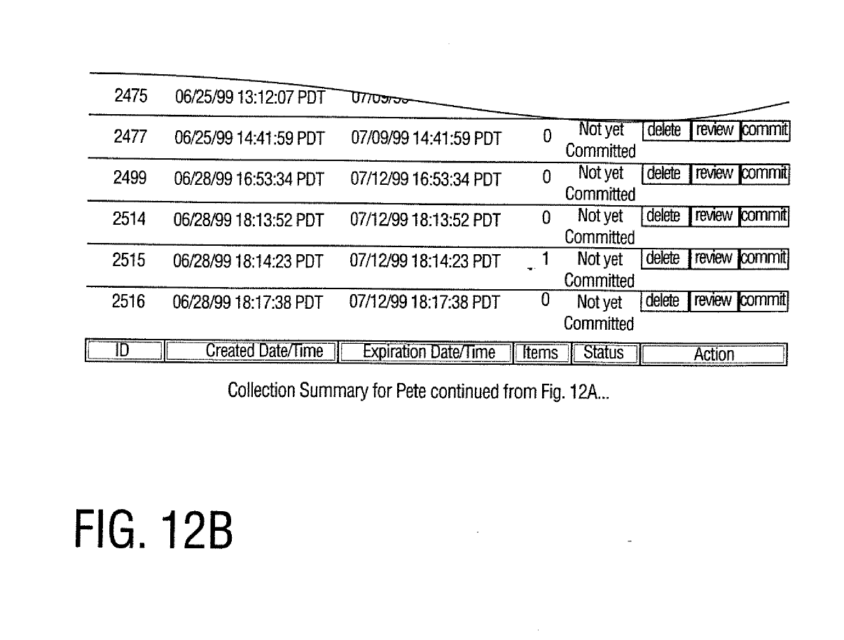

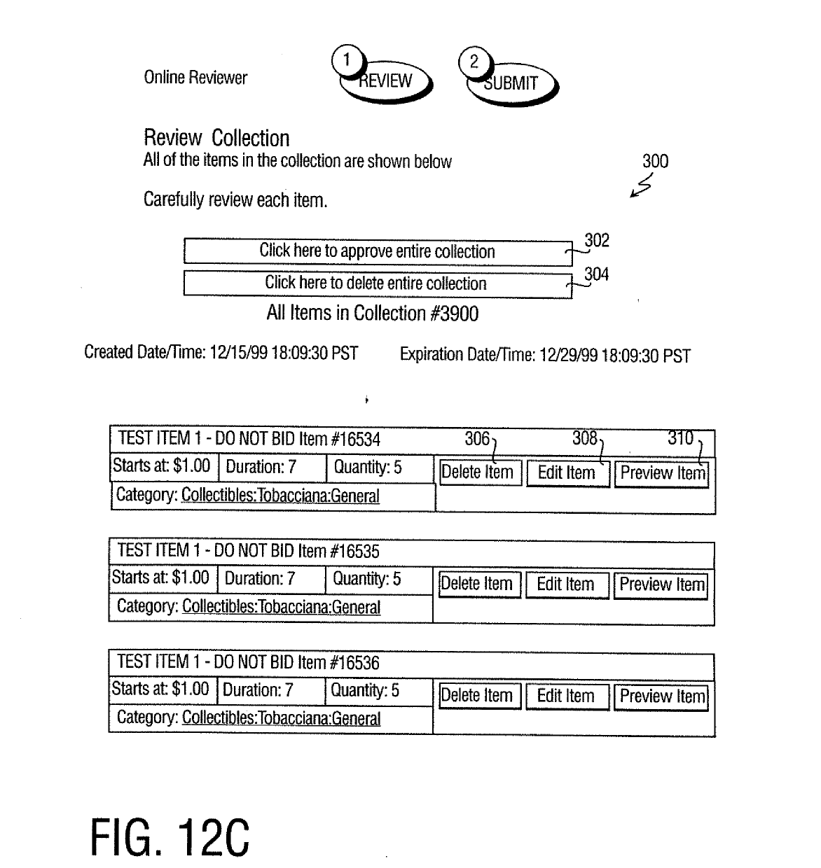

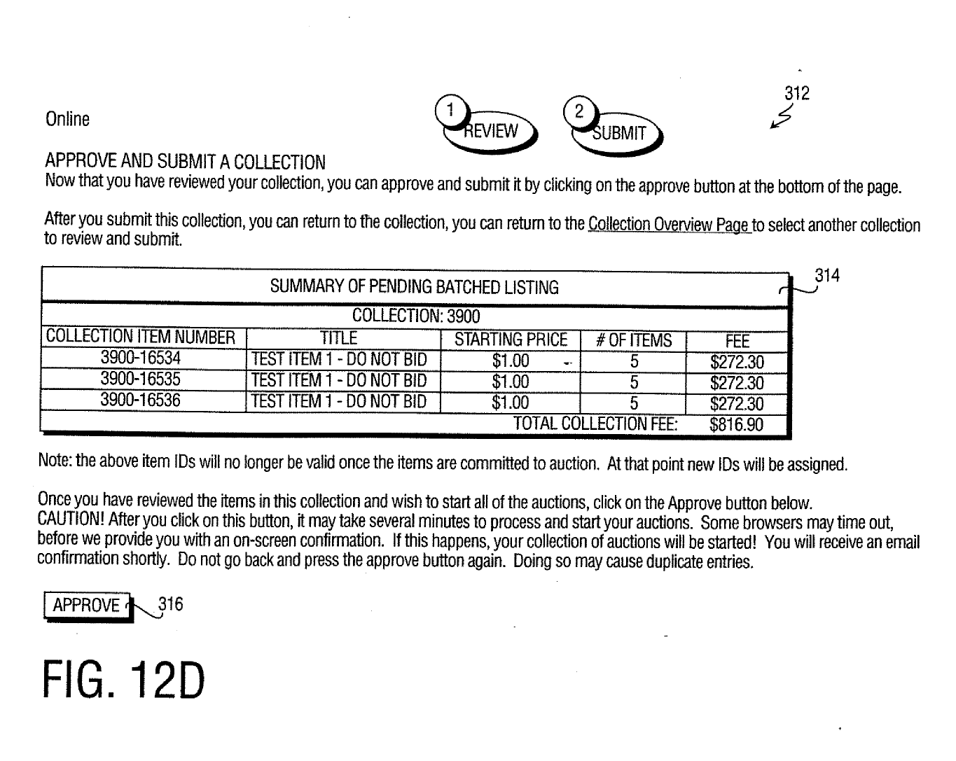

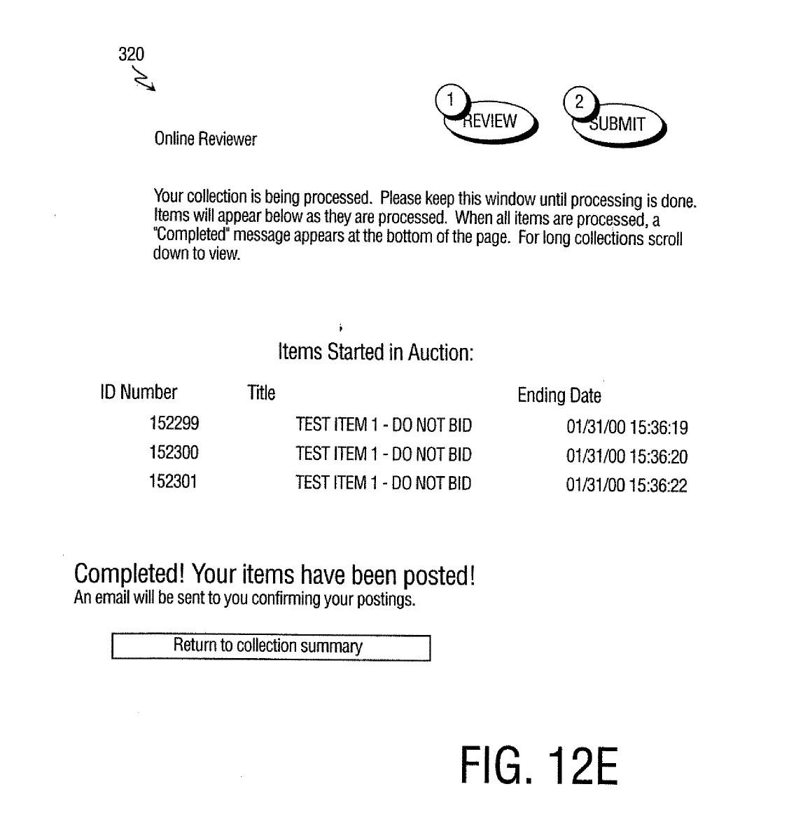

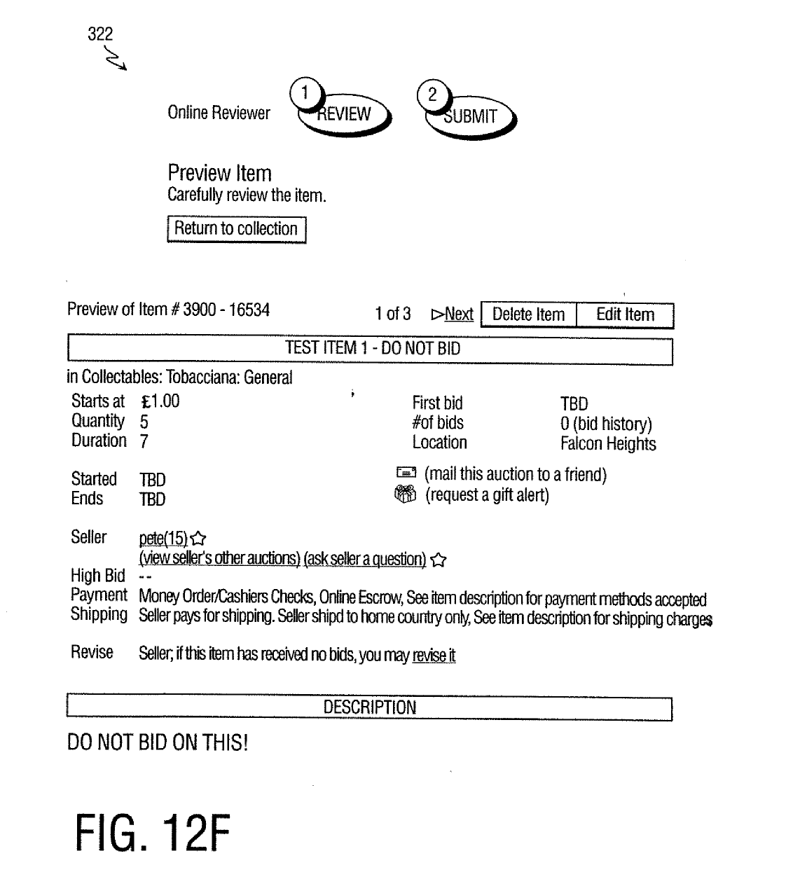

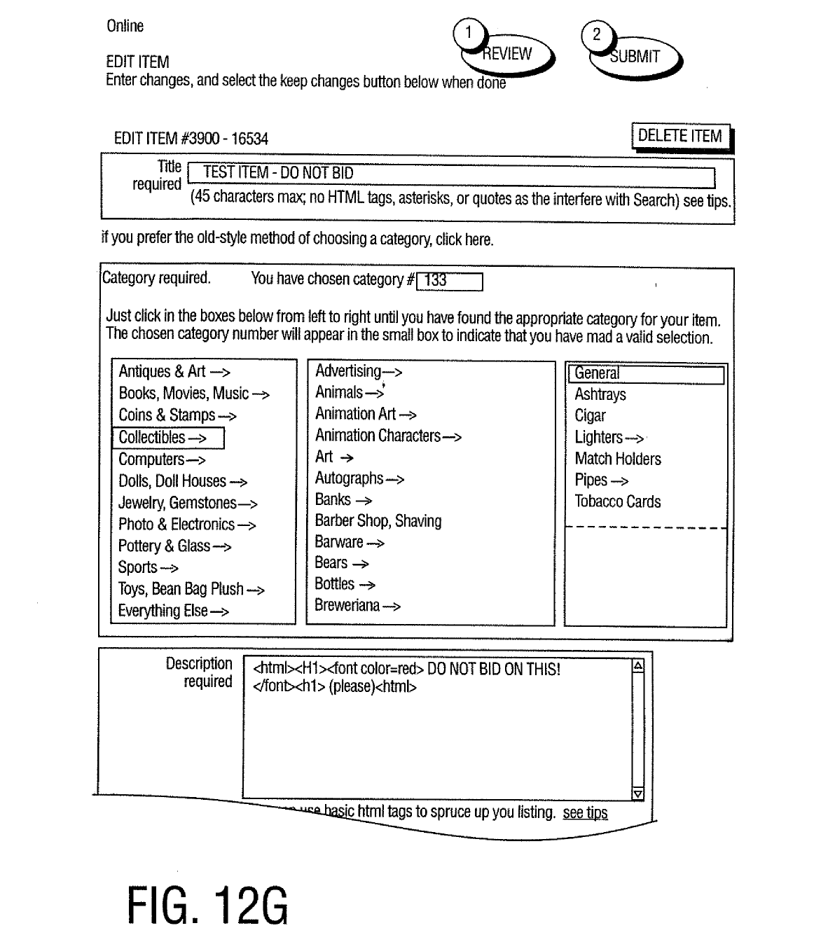

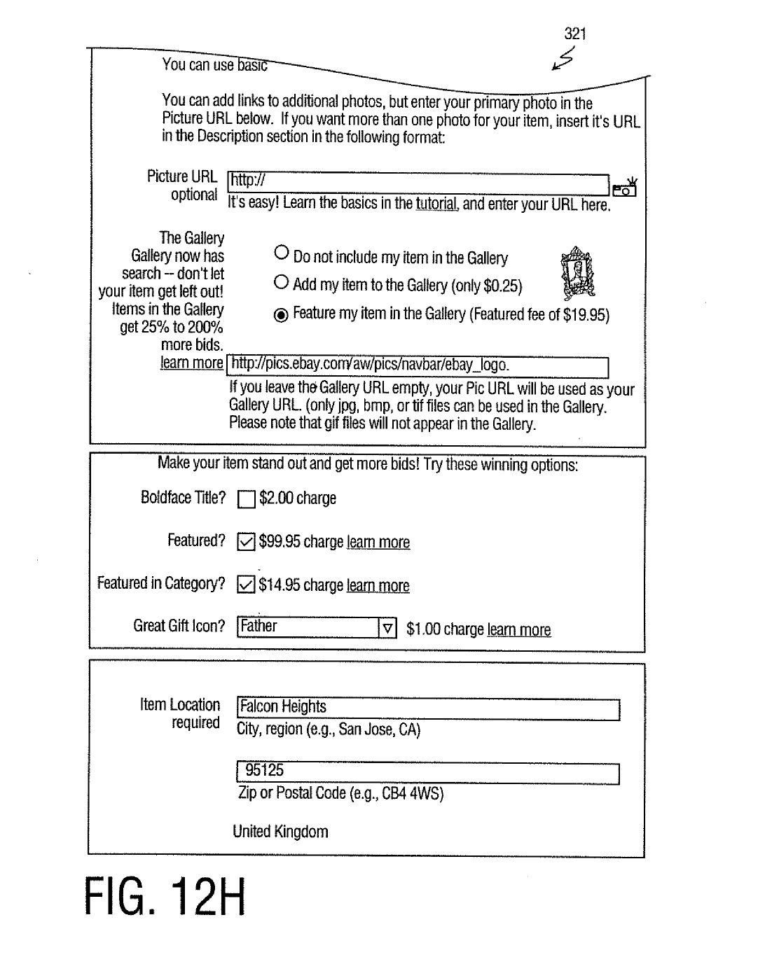

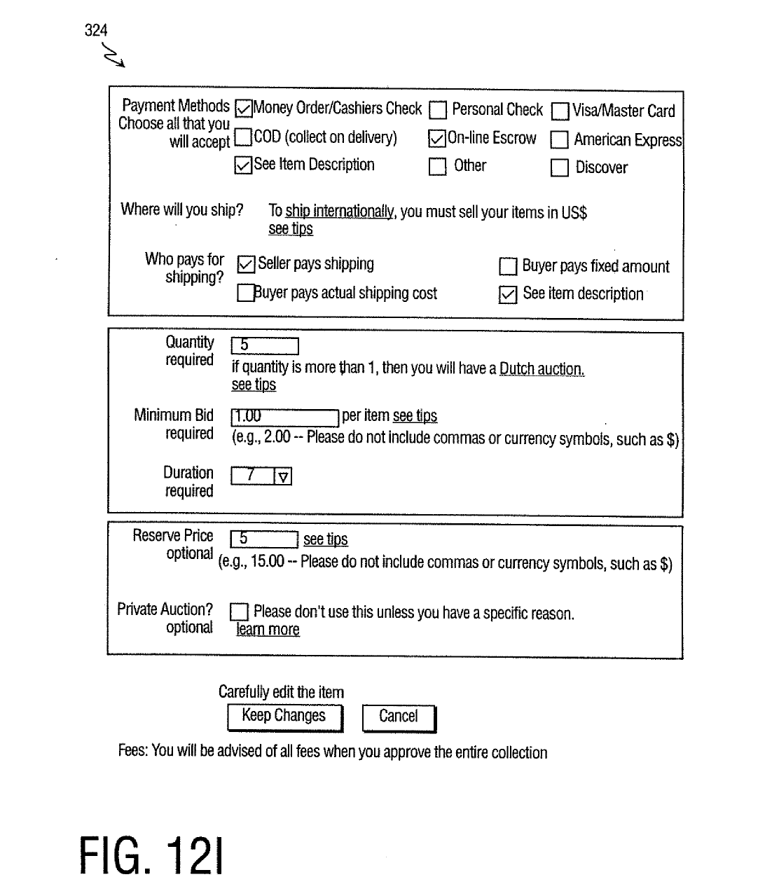

At block 252, the transaction application 90 sends an e-mail message to the sending user, the e-mail message presenting a listing of the transaction descriptions 84, as discerned by the transaction application 90 from the batch text 86. In one embodiment, the e-mail presents a confirmation interface by including a URL that provides a link to a dynamically-generated markup language document (e.g., generated by the page server 12) that lists the collection of transaction descriptions 84 as stored within the items wait table 64. In one embodiment, the confirmation e-mail sent at block 252 includes a URL to a series of review interfaces that provide a submitting user with information regarding one or more collections of transaction descriptions 84 that have been submitted to network-based auction facility 10, and are being held in the items wait table 64 pending user confirmation or a user-specified live date. Further information regarding such an exemplary series of review interfaces is provided below with reference to FIGS. 12A-12H.

At block 254, the transaction application 90 receives approval from a submitting user to commit one or more collections of transaction descriptions 84 to an active state (i.e., into a state wherein a transaction process within the parameters of the description commences) responsive to which, at block 256, the transaction application 90 commits the one or more collections from the items wait table 64 to the live items tables 42.

FIGS. 12A and 12B provide an exemplary embodiment of a “review collection summary” interface 286 that may be presented to a submitting user responsive to selection of a URL embodied, for example, within the confirmation e-mail message transmitted at block 252. Specifically, the interface 286 provides a tabulated list of collections of transaction descriptions 84 that are currently pending (i.e., not committed) within the network-based auction facility 10. Each of these collections is identified by a respective collection identifier 294, and has delete, review and commit buttons 288, 290 and 292 associated therewith. The buttons 288, 290 and 292 are user-selectable to delete, review or commit an associated collection.

FIG. 12C illustrates an exemplary embodiment of a “review collection” interface 300 that may be presented responsive to user-selection of the “review” button 290 associated with a collection listing displayed in the interface 286. The “review collection” interface 300 presents an “approve” button 302 that is user-selectable to approve an entire collection, and a “delete” button 304 that is user-selectable to delete the entire collection. A table for of each transaction description 84 within a respective collection is also provided, and “delete”, “edit” “preview” buttons 306, 308 and 310 allow a user to perform respective operations with respect to transaction descriptions 84 on an individual basis.

FIG. 12D illustrates an exemplary “approve and submit collection” interface 312 that may be invoked responsive to user-selection of the “commit” button 292, presented within the “review collection” summary interface 286 shown in FIG. 12A. The interface 312 provides a tabulated listing of transaction descriptions 84 included within the relevant collection and an “approve” button 316 that is user-selectable to approve (or commit) the relevant collection.

FIG. 12E illustrates a confirmation interface 320 that reports successful committing of a specified collection of transaction descriptions 84, for example responsive to user-selection of the “approve” button 316 shown in FIG. 12C.

FIG. 12E illustrates an exemplary “preview item” interface 322 that may be presented responsive to user-selection of the “preview” button 310 of the interface 300 shown in FIG. 12B. The “preview item” interface 322 presents to the submitting user a view of how the transaction description will actually be presented when a transaction process (e.g., an auction process) is commenced based on the transaction description 84. The “preview item” interface 322 is useful to provide the submitting user a final view of information that will be presented to a potential buyer accessing the network-based auction facility 10. FIGS. 12G-12I display an exemplary “edit item” interface 324 that may be invoked responsive to user-selection of the “edit” button 308 within the “review collection” interface 300 illustrated in FIG. 12B. The “edit item” interface 324 allows a user to edit and modify any of the data items included within a transaction description while the transaction description is pending within the items wait table 64, and before a transaction process based on the transaction description 84 goes “live”.

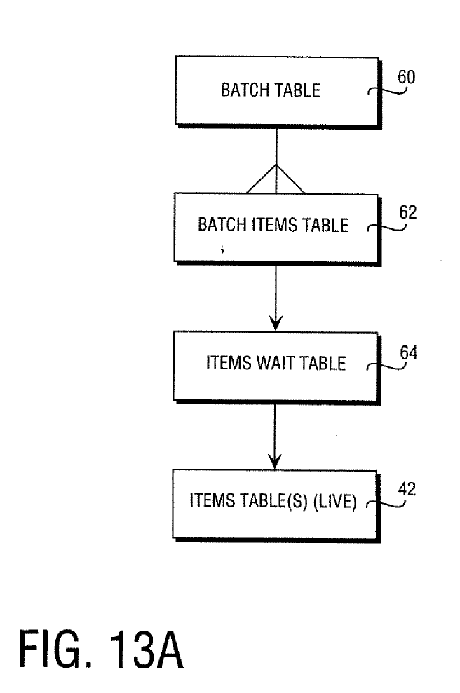

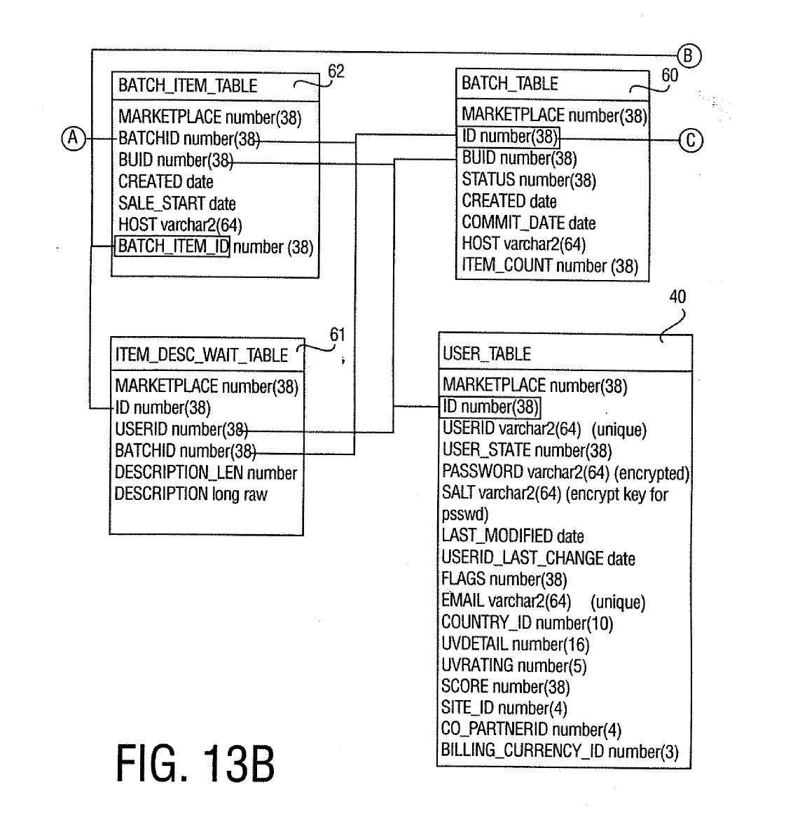

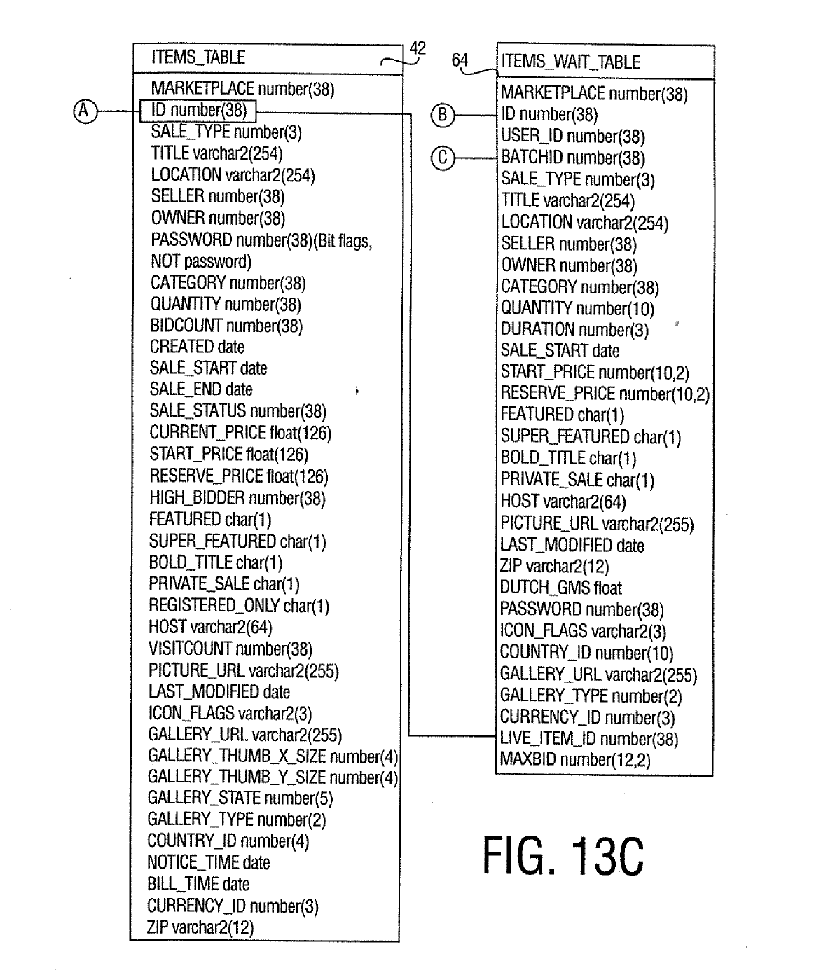

FIGS. 13A-13C provide further details regarding the database structure, maintained by the database engine server 22, to support the above-described methodologies.

At FIG. 13A, the batch table 60 includes a record for each collection of transaction descriptions 84 as originally described, for example, within batch text 86 received at the network-based auction facility 10.

A one-to-many relationship exists between the batch table 60 and the batch items table 62, which contains transaction descriptions 84 extracted by the parser 92 from the batch text 86 into the database 32, but which have not as yet gone live.

The items wait table 64 stores loaded transaction descriptions 84 that are waiting to go live as described above. The items tables 42 stores records of the actual transaction descriptions 82 that have gone live by the initiation of the transaction process (e.g., an auction process or an offer for sales prices) by the network-based auction facility 10.

FIGS. 13B and 13C illustrate an entity relationship diagram providing further details regarding the fields that are supported by the batch, batch items, items wait, items, user and related tables.

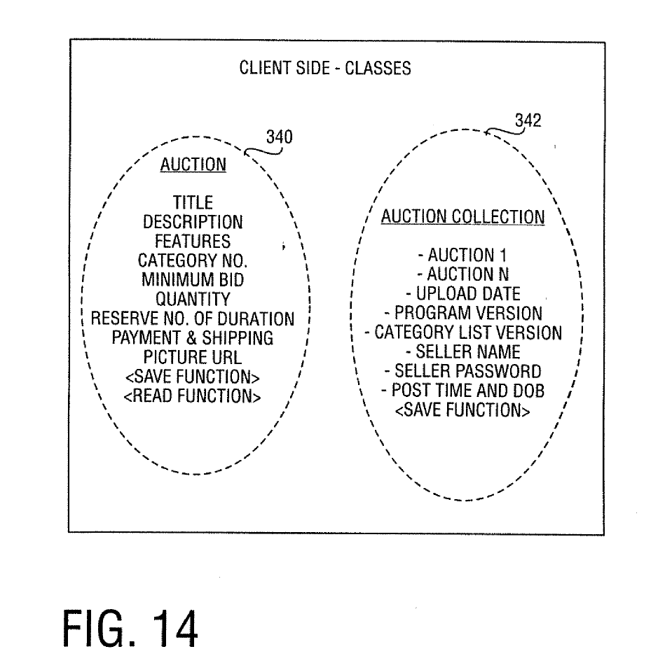

FIG. 14 is a class diagram illustrating classes, according to an exemplary embodiment, that may be provided on the client-side to support the above-described functionality. An auction class 340 contains the information regarding a transaction (e.g., an auction) that is needed by the server-side to commence a transaction process. Specifically, the auction class includes title, description, features of auction, category number, minimum bid, quantity, payment and shipping options and other data. The auction class 340 may also contain functions to save itself and read necessary information from a binary file.

An auction collection class 342 operates as a container class for a number of auction class data members. An auction collection is represented by the auction collection class. In addition to all the auctions contained in this class, the auction collection class 342 also contains the date on which a collection was last uploaded so that the number of collections uploaded within a predetermined time period may be limited (e.g., once every twenty-four hour period). The auction collection class 342 also embodies a function to save the collection. Specifically, when saving a collection, the auction collection class 342 calls a save function of each of its member auction classes 340. It also saves the following information to a file:
1. The version of the upload application that saved the relevant collection;
2. The version of a predetermined list (e.g., category list) utilized to create a transaction description;
3. A submitting seller's user name and password;
4. The date and time to post the transactions described in the collection of transaction descriptions; and
5. The date on which the relevant collection of transaction descriptions was last uploaded.

All information may, in one embodiment, be saved utilizing the Visual Basic Function (Put) and may be read back from the relevant file utilizing the function (Get).

When a collection is uploaded to the network-based transaction facility, the relevant data file is simply saved to a random file name and communicated to the network-based transaction facility as an e-mail or utilizing FTP.

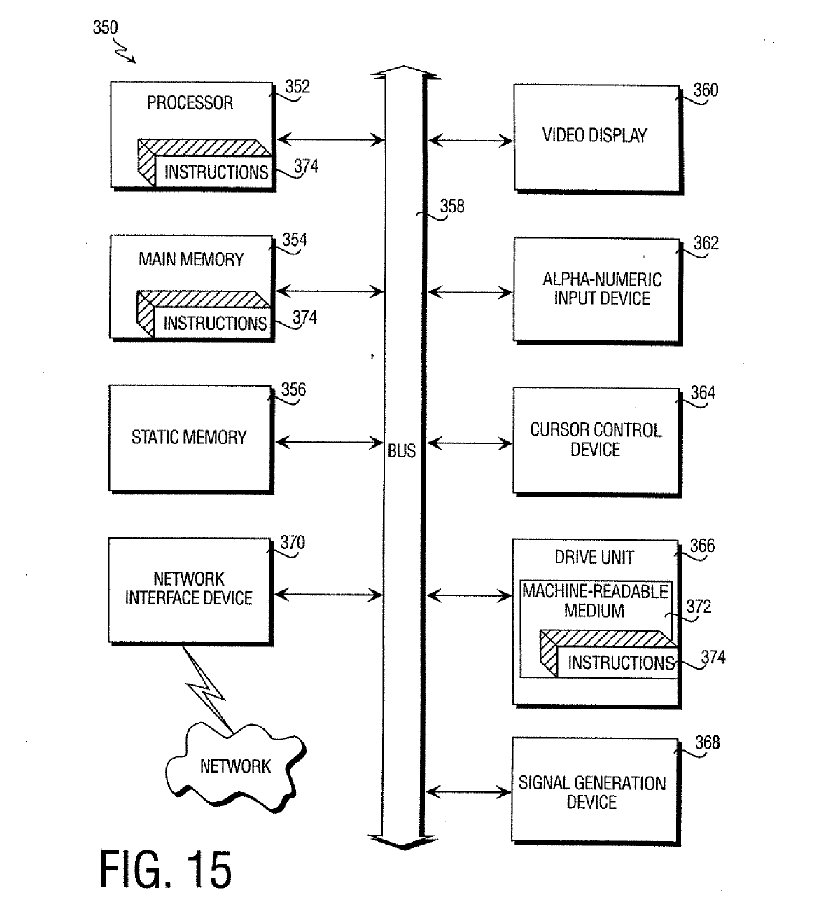

FIG. 15 shows a diagrammatic representation of machine in the exemplary form of a computer system 350 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 350 includes a processor 352, a main memory 354 and a static memory 356, which communicate with each other via a bus 358. The computer system 350 may further include a video display unit 360 (e.g., a liquid crystal display (LCD) or a cathode ray tube (CRT)). The computer system 350 also includes an alpha-numeric input device 362 (e.g. a keyboard), a cursor control device 364 (e.g. a mouse), a disk drive unit 366, a signal generation device 368 (e.g. a speaker) and a network interface device 370.

The disk drive unit 366 includes a machine-readable medium 372 on which is stored a set of instructions (i.e., software) 374 embodying any one, or all, of the methodologies described above. The software 374 is also shown to reside, completely or at least partially, within the main memory 354 and/or within the processor 352. The software 374 may further be transmitted or received via the network interface device 370. For the purposes of this specification, the term “machine-readable medium” shall be taken to include any medium which is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals.

Thus, a method and system to define and upload multiple transaction descriptions to a network-based transaction facility have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A non-transitory machine-readable storage medium storing a set of instructions that, when executed by one or more processors of a machine, cause the machine to perform operations comprising:
receiving, at a network-based transaction facility, a batch text file including a plurality of transaction descriptions generated at a client machine, each transaction description including a description of an item to be transacted, the batch text file further including one or more tags, the one or more tags demarcating each transaction description of the plurality of transaction description included in the batch text file;
instantiating a dedicated parsing process for the batch text file;
identifying each transaction description in the batch text file using the one or more tags;
constructing a collection of transaction listings from the identified transaction descriptions, each transaction listing in the collection of transaction listings including an offer for sale of an item described by a corresponding transaction description included in the batch text file; and
committing the collection of transaction listings to an active state, the committing of the collection of transaction listings to the active state initiating a transaction process by the network-based transaction facility.

2. The non-transitory machine-readable storage medium of claim 1, wherein the operations further comprise transmitting a confirmation message to the client machine, the confirmation message including a list of the collection of transaction listings.

3. The non-transitory machine-readable storage medium of claim 2, wherein the message allows a user to confirm approval to submit the collection of transaction listings to the active state, wherein the collection of transaction listings are committed to the active state in response to receiving approval from the user.

4. The non-transitory machine-readable storage medium of claim 1, wherein the operations further comprise verifying a format of each transaction description included in the plurality of batch text files.

5. The non-transitory machine-readable storage medium of claim 1, wherein the batch text file is received via electronic mail message.

6. The non-transitory machine-readable storage medium of claim 1, wherein the one or more tags comprise a tag delimiter and a tag title.

7. The non-transitory machine-readable storage medium of claim 6, wherein the identifying of each transaction description in the batch text file includes:
recognizing respective tag delimiters of the one or more tags included in the first batch text file; and
parsing the first batch text file using the one or more tags.

8. A method comprising:
receiving, at a network-based transaction facility, a batch text file including a plurality of transaction descriptions generated at a client machine, each transaction description including a description of an item to be transacted, the batch text file further including one or more tags, the one or more tags demarcating each transaction description of the plurality of transaction description included in the batch text file;
instantiating a dedicated parsing process for batch text file;
identifying each transaction description in the batch text file using the one or more tags;
constructing, by a hardware processor, a collection of transaction listings from the identified transaction descriptions, each transaction listing in the collection of transaction listings including an offer for sale of an item described by a corresponding transaction description included in the batch text file; and
committing the collection of transaction listings to an active state, the committing of the collection of transaction listings to the active state initiating a transaction process by the network-based transaction facility.

9. The method of claim 8, further comprising transmitting a confirmation message to the client machine, the confirmation message including a link to a dynamically-generated markup language document, the dynamically-generated markup document including a list of the collection of transaction listings.

10. The method of claim 9, wherein the message includes a confirmation interface allowing a user to confirm approval to submit the collection of transaction listings to the active state, wherein the collection of transaction listings are committed to the active state in response to receiving approval from the user via the confirmation interface.

11. The method of claim 8, further comprising storing, prior to committing the collection of transaction listings to the active state, the collection of transaction listings in an items wait table, the items wait table storing a plurality of transaction listings pending confirmation from a submitting user.

12. The method of claim 8, further comprising assigning each transaction listing in the collection of transaction listings a collection identifier and a unique identifier, the collection identifier identifying the collection of transaction listings, the unique identifier uniquely identifying respective transaction listings in the collection of transaction listings.

13. The method of claim 8, further comprising verifying a format of data included in each transaction description included in the batch text file.

14. The method of claim 8, wherein each transaction description includes a category description describing a category of items offered for sale, the category description being received from input interface of a client application executing on the client machine, the category description being selected from a list of categories defined by a category structure;

15. The method of claim 14, further comprising transmitting a data file to the client machine, the data file including an updated category structure specifying an updated list of categories for user-selection as the category description, the transmitting of the data file serving to synchronize the list of categories available for user-selection as the category description.

16. The method of claim 8, wherein the batch text file is received via electronic mail message.

17. The method of claim 8, wherein the one or more tags comprise a delimiter and a title.

18. The method of claim 8, wherein the identifying each transaction description in the batch text file comprises:
recognizing the one or more tags included in the batch text file; and
parsing the batch text file using the one or more tags.

19. The method of claim 8, wherein the committing the collection of transaction listings to the active state includes storing the collection of transaction listings into a live items table.

20. A system comprising:
a memory;
a communications interface;
a processor operatively coupled to the memory and the communications interface, the processor to operate a transaction application to receive a plurality of batch text files, each batch text file of the plurality of batch text files including a plurality of transaction descriptions generated at a client machine, each transaction description including a description of an item to be transacted, the batch text file further including one or more tags, the one or more tags demarcating each transaction description of the plurality of transaction descriptions included in the batch text file, the transaction application further to instantiate a dedicated parsing process for a first batch text file of the plurality of batch text files, the instantiating of the dedicated parsing process for the first batch text file including identifying each transaction description in the first batch text file using the one or more tags, and constructing a collection of transaction listings from the identified transaction descriptions, each transaction listing in the collection of transaction listings including an offer for sale of an item described by a corresponding transaction description included in the first batch text file, the transaction application further to commit the collection of transaction listings to an active state, the committing of the collection of transaction listings to the active state initiating a transaction process by a network-based transaction facility.
